(19) United States
(12) Patent Application Publication
(10) Pub. No.: US 2007/0248386 A1
(43) Pub. Date: Oct. 25, 2007

(54) IMAGE FORMING APPARATUS

(75) Inventor: Kazuo UDUKI, Abiko-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/735,061

(22) Filed: Apr. 13, 2007

(30) Foreign Application Priority Data
Apr. 21, 2006 (JP) 2006-117689

(51) Int. Cl. G03G 15/01

(52) U.S. Cl. 399/299; 399/302

(57) ABSTRACT

An image forming apparatus includes: first to fourth image forming portions which form single-color images having basic colors;

a fifth image forming portion which forms a single-color image having accessory color different from the basic colors;

a belt member where toner images formed by the image forming portions are superimposed;

a driving roller rotates the belt member; and

a driven roller rotated by means of the rotation of the belt member, and in this apparatus, at least the first to third image forming portions are arranged in a position on an upper stream side and on a lower stream side with respect to the driven roller in a moving direction of the belt member, and at least the fifth image forming portion is arranged in a position on an upper stream side and on a lower stream side with respect to the driving roller in the direction.

### BACKGROUND OF THE INVENTION

1. Field of the Invention

The present invention relates to an image forming apparatus that forms a multi-color image using basic colors including black, cyan, magenta and yellow and the other accessory colors.

2. Description of the Related Art

Electrophotographic type color image forming apparatuses include an image forming apparatus that forms color images on a plurality of photosensitive drums 50 provided for respective colors and superimposes these single-color images on a transfer belt 51 so as to form a multi-color image as shown in FIG. 3.

Although such a tandem-type image forming apparatus can realize high-speed image formation like monochrome image formation, optical systems 52, photosensitive drums 50 and transfer portions 53 are present separately for respective colors, thereby frequently arising a problem of registration alignment between the respective colors due to dispersion of respective elements. This problem is solved mostly by forming an image for superposing location on the transfer belt 51 and reading this image via a sensor so as to adjust writing start time.

However, when a speed fluctuation is caused on the transfer belt 51 by its stretch, deflection of a driven roller and the like, the read amount by means of the sensor deviates from the actual amount. In a conventional method, therefore, the stretch of the transfer belt 51 is detected, and superposing positions of plural colors on the transfer belt 51 are controlled based on the detected stretch (Japanese Patent Application Laid-Open No. 2005-010701).

On the other hand, the present electrophotographic type color image forming apparatuses are expected to provide higher-quality pictures. For this reason, a six-color tandem-type image forming apparatus, in which an intermediate color and a special color are added to four basic colors including black, cyan, magenta and yellow, is proposed.

In the six-color tandem-type image forming apparatus, it is not desirable that all photosensitive drums are arranged on one side of a transfer belt stretched between a driving roller and a driven roller unlike the conventional apparatuses because a space for installing a main body increases. It is, therefore, considered that the photosensitive drums are arranged on both sides of the transfer belt stretched between the driving roller and the driven roller, and suitable free spaces on the stretch side of the transfer belt zoned by the driving roller, the driven roller, a tension roller and the like.

However, when the plural photosensitive drums are arranged in a dispersed manner, the influence of the stretch and disturbance of the transfer belt is not uniform on the entire position of the transfer belt. That is to say, since the belt tension becomes smaller on a driving lower stream area of the driving roller than that on a driving upper stream area, the speed fluctuation easily occurs on the driving lower stream area. For this reason, superposing accuracy of the images formed by the image forming portions arranged on the driving lower stream area becomes lower than superposing accuracy of the images formed by the image forming portions arranged on the driving upper stream area. As a result, color shift of a final image becomes noticeable due to a certain color of an image to be formed. On the other hand, even when the method of detecting the stretch of the transfer belt so as to control it is used, it is difficult to eliminate the color shift due to displacement of the superposing of respective colors.

### SUMMARY OF THE INVENTION

The present invention provides an image forming apparatus which is capable of depressing color shift of an image when a multi-color image using five or more colors is formed.

The present invention also provides an image forming apparatus including:

a first image forming portion which forms single-color image having black;

a second image forming portion which forms single-color image having cyan;

a third image forming portion which forms single-color image having magenta;

a fourth image forming portion which forms single-color image having yellow;

a fifth image forming portion which forms a single-color image having accessory color different from the said colors;

a belt member where toner images formed by the first to fifth image forming portions are superimposed;

a driving roller which drives to rotate the belt member; and

a driven roller on which the belt member is suspended and which is rotated by the rotation of the belt member,

wherein at least the first to third image forming portions which form the black, cyan and magenta images are arranged in position on an upper stream side with respect to the driving roller and on a lower stream side with respect to the driven roller in a moving direction of the belt member, and at least the fifth image forming portion is arranged in a position on an upper stream side with respect to the driven roller and on a lower stream side with respect to the driving roller in a rotating direction of the belt member.

Further features of the present invention will become apparent from the following description of exemplary embodiments (with reference to the attached drawings).

### BRIEF DESCRIPTION OF THE DRAWINGS

FIG. 1 is a sectional explanatory view illustrating an entire constitution of an image forming apparatus according to a first embodiment;

FIG. 2 is a sectional explanatory view illustrating an entire constitution of the image forming apparatus according to a second embodiment; and

FIG. 3 is a sectional explanatory view of an image forming apparatus according to a conventional technique.

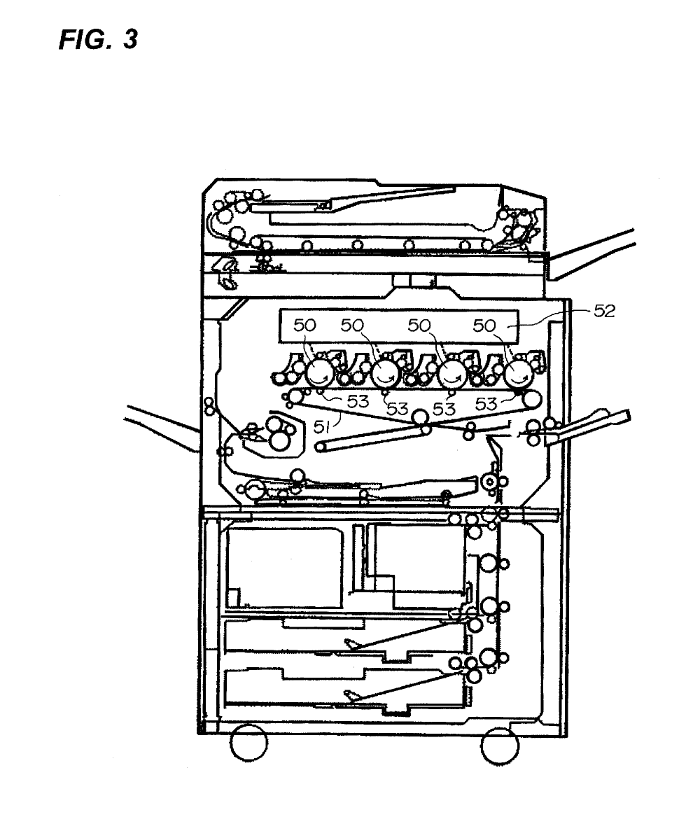

### DESCRIPTION OF THE EMBODIMENTS

An image forming apparatus according to one embodiment of the present invention is described in detail below with reference to the accompanying drawings.

### First Embodiment

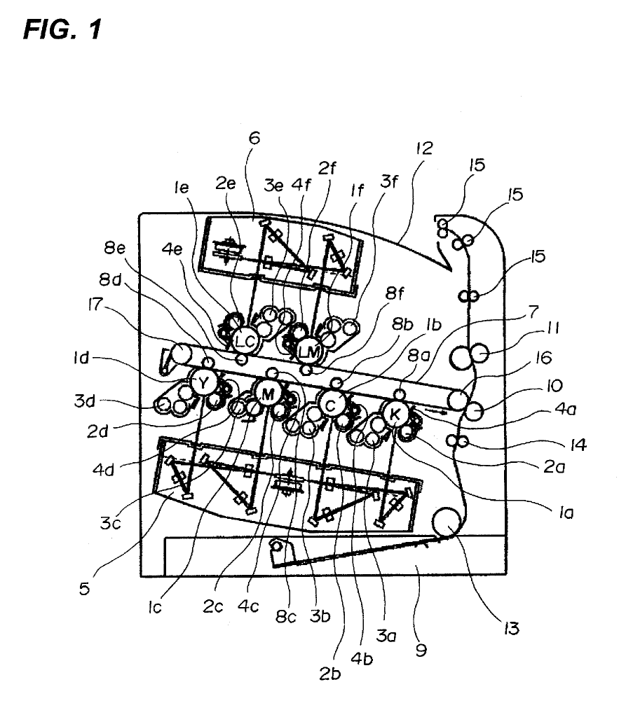

{The Entire Constitution of the Image Forming Apparatus} The entire constitution of an electrophotographic type image forming apparatus is simply described with reference to FIG. 1. FIG. 1 is a sectional explanatory diagram illustrating the entire constitution of the electrophotographic type image forming apparatus according to the embodiment (hereinafter, “image forming apparatus”). The image forming apparatus in this embodiment is a tandem-type full-color laser beam printer that uses a transfer type electrophotographic process.

In FIG. 1, K, C, M, Y, LC and LM are first to sixth image forming portions that form images using toners with respective colors including black, cyan, magenta, yellow, light cyan and light magenta corresponding to color separation components of a full-color image. Light cyan has the same hue as that of cyan and weaker concentration than that of cyan, and light magenta has the same hue as that of magenta and weaker concentration than that of magenta.

The first to sixth image forming portions form different color images but have the same constitution. In FIG. 1, symbols a, b, c, d, e and f mean members of the image forming portions K, C, M, Y, LC and LM, respectively.

In the respective image forming portions K, C, M, Y, LC and LM, electrophotographic processing units such as a charging unit 2, a developing unit 3 and a cleaning unit 4 are arranged around a photosensitive drum 1 as an image bearing member. The charging unit 2 uniformly charges the surface of the photosensitive drum 1, and the developing unit 3 develops an electrostatic latent image formed by irradiating image exposing light to the charged photosensitive drum 1 using toner so as to form a visible image. The cleaning unit 4 eliminates toner remaining on the photosensitive drum 1 after a toner image formed on the photosensitive drum 1 is transferred to a transfer material.

Scanner units 5 and 6 that selectively expose the photosensitive drums 1 based on image information so as to form latent images are provided on an inner side of the image forming apparatus main body.

The photosensitive drums 1 of the image forming portions K, C, M, Y, LC and LM are arranged so as to be in contact with an intermediate transfer belt (hereinafter, “transfer belt) 7 as a belt member. Primary transfer rollers 8 are provided to positions across the belt 7 from the photosensitive drums 1, respectively.

On the other hand, a sheet cassette 9 that stores recording materials S is mounted below the apparatus main body. The recording material S passes through a secondary transfer portion 10 and a fixing unit 11 so as to be conveyed to a discharge portion 12 at the upper portion of the apparatus main body by a conveyance unit.

At the time of image formation, the photosensitive drums 1 are rotated, and the scanner units 5 and 6 selectively expose the photosensitive drums 1 which are uniformly charged by the charging unit 2 so that electrostatic latent images are formed. The electrostatic latent images are developed by the developing unit 3 so that single-color toner images having respective colors are formed on the photosensitive drums 1, respectively. The toner images are sequentially superimposed on the transfer belt (intermediate transfer member) 7 as the belt member by applying a bias to the primary transfer rollers 8, so that a color image is formed.

The recording material is conveyed to the secondary transfer portion 10 by a feed roller 13 and a conveyance roller 14 forming a conveyance unit so as to synchronize with the image formation, and a transfer bias is applied to the secondary transfer roller so that the toner image on the transfer belt 7 is transferred to the recording material. After the recording material is heated and pressurized by the fixing unit 11 so that the toner image is fixed, the recording material is discharged into the discharge portion 12 by a discharge roller 15.

{Relationship between the Transfer Belt and the Imaging Forming Portion} A positional relationship between the transfer belt 7 and the image forming portions K, C, M, Y, LC and LM in the image forming apparatus is described below.

The transfer belt 7 is made of an endless belt member, and this belt is suspended between a driving roller 16 which receives a driving force from a motor so as to be rotated and a driven roller 17 which is driven to be rotated by the rotation of the transfer belt 7. The transfer belt 7 is supported with constant tension being applied thereto. The transfer belt 7 rotates to a counterclockwise direction in FIG. 1 by the rotation of the driving roller 16 at the time of forming an image. The driving roller 16 serves also as a roller which pressure-contacts with a secondary transfer roller that applies a secondary transfer bias via the transfer belt 7 in the secondary transfer portion.

Single-color toner images with respective colors are sequentially superimposed so as to be transferred to the rotating transfer belt 7, and at this time, position accuracy of the respective colors is important. When the superposing positions are displaced, the displacement which is color shift causes a defective image.

On the other hand, noticeability of the color shift is closely related to the toner lightness of a toner image. That is to say, in the case of light-colored toner images of light magenta and light cyan whose lightness is high, the color shift is less noticeable than the case of toner images of black, magenta and cyan whose lightness is low. For this reason, it is necessary that toner images whose color shift is noticeable are formed on a portion where the belt speed is as stable as possible.

For this reason, the influence of an irregular speed of the transfer belt 7 should be reduced as much as possible. The transfer belt 7 which rotates by the rotation of the driving roller 16 has constant belt tension in an area between the driving roller 16 and the driven roller 17 on an upper stream side which is adjacent to the driving roller 16 (hereinafter, “driving upper stream area”) in the rotating direction. The irregularity of the speed with respect to the moving speed can be regarded as equivalent. On the other hand, as to the transfer belt 7 on an area between the driving roller 16 and the driven roller 17 on a lower stream side which is adjacent to the driving roller 16 (hereinafter, “driving lower stream area”), when a diameter of the driven roller 17 is eccentric, a speed error of the eccentric portion is applied as jitter (fluctuation) to the belt moving speed. Further, since the belt tension in the driving lower stream side is weaker than that in the driving upper stream area, the irregularity of the speed easily occurs.

That is to say, when the transfer belt 7 is supported by the two rollers (the driving roller 16 and the driven roller 17) like this embodiment, the behavior of the transfer belt 7 differs on the front and rear sides of the driving roller 16. Alignment accuracy of registration by means of the photosensitive drums being in contact with the driving lower stream area of the transfer belt 7 often becomes worse than alignment accuracy by means of the photosensitive drums 1 being in contact with the driving upper stream area.

For this reason, in this embodiment, the four image forming portions K, C, M and Y which form images of black, cyan, magenta and yellow as basic colors in the six image forming portions K, C, M, Y, LC and LM which transfer toner images onto the transfer belt 7 are arranged in a position on the upper stream side with respect to the driving roller 16 and on the lower stream side with respect to the driven roller 17 in the rotating direction of the transfer belt 7.

On the other hand, the two image forming portions LC and LM which form images of light cyan and light magenta as accessory colors other than the basic colors are arranged in position on the upper stream side with respect to the driven roller 17 and on the lower stream side with respect to the driving roller 16 in the rotating direction of the transfer belt 7.

When the respective image forming portions are arranged in the above manner, the photosensitive drums 1 which form the primary-color images are arranged on the tension surface of the transfer belt 7 between the driving roller 16 and the driven roller 17. For this reason, the color shift of the basic color images is reduced.

On the other hand, the photosensitive drums 1 which form the accessory-color images are arranged on a loosen side of the transfer belt 7 from the driven roller 17 to the driving roller 16. Therefore, the accessory-color images possibly have color shift larger than that of the primary-color images. However, since the accessory-color images are independent from the primary-color images and their lightness is comparatively high, color shift which occurs in the accessory-color images is difficultly noticeable. As a result, even when the behavior of the transfer belt 7 is particularly detected and controlled, the color shift can be made to be unnoticeable.

In this embodiment, the image forming portions K, C, M and Y for the basic colors are arranged below the transfer belt 7, and the image forming portions LC and LM for the accessory colors are arranged above the transfer belt 7. For this reason, the space in the apparatus main body can be used effectively, and thus the apparatus can be downsized. That is to say, a conveyance path for conveying recording materials to an upper direction of the image forming apparatus is provided, exposing devices of the image forming portions K, C, M and Y are provided on a lower surface side of the transfer belt, and exposing devices of the image forming portions LC and LM are provided to an upper surface side of the transfer belt. With such a constitution, the length in widthwise direction of the image forming apparatus can be shortened, so that the image forming apparatus can be downsized.

In this embodiment, the image forming portion of yellow having high lightness is provided to the driving upper stream side, but since the lightness of yellow is high, it may be provided to the driving lower stream side.

### Second Embodiment

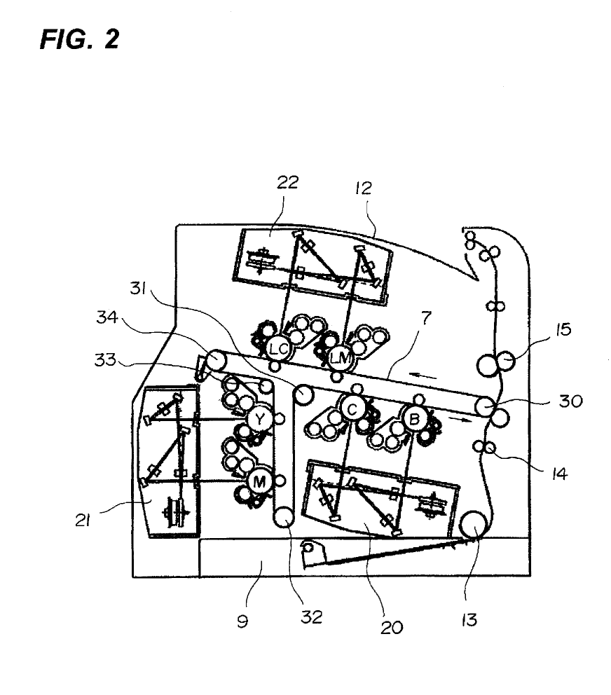

The apparatus according to a second embodiment is described below with reference to FIG. 2. Since the basic constitution of the apparatus in this embodiment is the same as that in the first embodiment, the description about the overlapped portions is not repeated, and only the constitution which is characteristic of the second embodiment is described. The members having the same functions as those in the first embodiment are designated by the same reference numerals.

The image forming apparatus in the second embodiment is provided with three scanner units 20, 21 and 22 for writing images in which two laser beams can be scanned independently in one case in order to obtain a freedom degree of the arrangement of the image forming portions in the apparatus main body. Accordingly, the transfer belt 7 is supported to be bent into a T shape by one driving roller 30 and four driven rollers 31, 32, 33 and 34.

The image forming portions K and C for black and cyan are arranged in an area (hereinafter, “first area”) zoned by the driving roller 3 and the driven roller 31 on the upper stream side (first driven roller) 31 in the rotating direction of the transfer belt 7. Further, the image forming portions M and Y for magenta and yellow are arranged in an area (hereinafter, “second area”) zoned by the driven roller 32 on the upper stream side with respect to the driven roller 31 and the driven roller 33 on the upper stream side with respect to the driven roller 32.

The image forming portions LC and LM for light cyan and light magenta which form accessory-color images are arranged in a third area zoned by the driving roller 30 and the driven roller 34 on the lower stream side in the rotating direction of the transfer belt 7.

When the plural driven rollers 31, 32, 33 and 34 zone the belt areas, the belt tension is the highest between the driving roller 30 and the driven roller 31. The belt tension becomes lower between the driven rollers 31 and 32, between the driven rollers 32 and 33 and between the driven rollers 33 and 34, in this order, and the belt tension is the lowest between the driven roller 34 and the driving roller 30.

In general, black in the basic colors has the lowest lightness, and the lightness becomes higher in the order of cyan, magenta yellow. As the lightness becomes higher, visual sensitivity with respect to the images becomes lower. That is to say, the color shift of black is the most noticeable, and the color shift is less noticeable in the order of cyan, magenta and yellow. For example, even in an image where the color shift of black is visible, the color shift of yellow cannot be viewed.

For this reason, the photosensitive drums 1 for black and cyan as the basic colors whose lightness is high are arranged in the first area where the tension of the transfer belt 7 is the strongest. The photosensitive drums 1 for magenta and yellow are arranged in the second area where the belt tension is the second strongest. The photosensitive drums 1 for light cyan and light magenta as accessory colors are arranged in the area where the tension is the weakest between the driven roller and the driving roller.

As a result, the influence such that the belt displacement is recognized as the color shift in the image becomes weak. When the plural driven rollers are used, the transfer belt 7 can be bent into various shapes. For this reason, the space in the apparatus main body can be effectively used, thereby downsizing the apparatus.

### Another Embodiment

In the second embodiment, the image forming portions M and Y for magenta and yellow are arranged in the area between the driven rollers 32 and 33, but may be arranged in the area between the driven rollers 31 and 32.

The above embodiments show the intermediate transfer belt as the belt member for directly transferring toner images from the photosensitive drums 1. The present invention, however, can be applied also to an image forming apparatus in which a conveyance belt for electrostatically adsorbing to convey recording materials is provided as the belt member, and toner images formed by the photosensitive drums are superimposed so as to be transferred onto a recording material conveyed by the conveyance belt.

The above embodiments describe light cyan and light magenta as the accessory colors, but the accessory colors do not have to be limited to them. For example, image forming portions for another accessory colors such as white (white toner) and achroma (transparent toner) may be provided.

According to the present invention, when the arrangements of the image forming portions are optimized, even if color shift occurs because the tension which is generated in the belt member rotated by the rotation of the driving roller vary between the suspension rollers of the belt member, the color shift can be made to be unnoticeable in the image.

The embodiments of the present invention are described above, but the present invention is not limited to the above embodiments, and various modifications can be made within the technical scope of the present invention.

This application claims the benefit of priority from the prior Japanese Patent Application No. 2006-117689 filed on Apr. 21, 2006 the entire contents of which are incorporated by reference herein.

What is claimed is:

1. An image forming apparatus, comprising:
a first image forming portion which forms single-color image having black;
a second image forming portion which forms single-color image having cyan;
a third image forming portion which forms single-color image having magenta;
a fourth image forming portion which forms single-color image having yellow;
a fifth image forming portion which forms a single-color image having accessory color different from the said colors;
a belt member where toner images formed by the first to fifth image forming portions are superimposed;
a driving roller which drives to rotate the belt member; and
a driven roller on which the belt member is suspended and which is rotated by the rotation of the belt member,
wherein at least the first to third image forming portions which form the black, cyan and magenta images are arranged in position on an upper stream side with respect to the driving roller and on a lower stream side with respect to the driven roller in a moving direction of the belt member, and at least the fifth image forming portion is arranged in a position on an upper stream side with respect to the driven roller and on a lower stream side with respect to the driving roller in a rotating direction of the belt member.

2. The image forming apparatus according to claim 1,
wherein the fourth image forming portion which forms the yellow image is arranged in a position on an upper stream side with respect to the driving roller and on a lower stream side with respect to the driven roller in the moving direction of the belt member.

3. The image forming apparatus according to claim 1, further comprising:
a transfer portion which transfers a toner image on an intermediate transfer member to a recording material,
wherein the first image forming portion which forms the black image is arranged on a side closer to the transfer portion than the other image forming portions in the moving direction of the belt member.

4. The image forming apparatus according to claim 1, further comprising:
a transfer portion which transfers a toner image on an intermediate transfer member to a recording material,
wherein the driving roller is a secondary transfer roller which supports the belt member in the transfer portion.

5. An image forming apparatus comprising:
a first image forming portion which forms single-color image having black;
a second image forming portion which forms single-color image having cyan;
a third image forming portion which forms single-color image having magenta;
a fourth image forming portion which forms single-color image having yellow;
a fifth image forming portion which forms a single-color image having accessory color different from said colors;
a belt member where toner images formed by the first to fifth image forming portions are superimposed;
a driving roller which drives to rotate the belt member; and
a plurality of driven rollers among which the belt member is suspended and which are driven to be rotated by means of the rotation of the belt member,
wherein the fifth image forming portion is arranged in a first area zoned by the driving roller and the driven roller on a lower stream side with respect to the driving rollers in a moving direction of the belt member.

6. The image forming apparatus according to claim 5,
wherein the first and second image forming portions which form the black and cyan images, respectively, are arranged in a first area zoned by the driving roller and a certain driven roller adjacent to the driving roller and on an upper stream side in a rotating direction of the belt member.

7. The image forming apparatus according to claim 5,
wherein the third and fourth image forming portions which form the magenta and yellow images, respectively, are arranged in a second area sandwiched by the driven rollers.

8. The image forming apparatus according to claim 5,
wherein the accessory color is any one of light cyan whose hue is the same as and whose concentration is lower than cyan, light magenta whose hue is the same as and whose density is lower than magenta, white and transparency.

9. The image forming apparatus according to claim 5,
wherein in the image forming apparatus which secondarily transfers a multi-color image primarily transferred to the belt member to a recording material so as to form an image, the driving roller is a secondary transfer roller which supports the belt member in the secondary transfer portion.
